(19) United States
(12) Patent Application Publication
(10) Pub. No.: US 2004/0166753 A1
(43) Pub. Date: Aug. 26, 2004

(54) Modification of fabric fibers

(76) Inventors: Dan B. Millward, Alameda, CA (US); William Ware Jr, Portola Valley, CA (US)

Correspondence Address: JACQUELINE S LARSON, P O BOX 2426, SANTA CLARA, CA, 95055-2426, US

(21) Appl. No.: 10/480,134

(22) PCT Filed: Jun. 10, 2002
(86) PCT No.: PCT/US02/18276

(51) Int. Cl. B32B 27/04

(52) U.S. Cl. 442/123; 427/396

(57) ABSTRACT

This invention is directed towards fibers of fabric or other fibrous substrates coated with amine-containing polymers. These polymers impart durable anti-microbial activity, renewable control of certain odors, and the capacity to bind certain materials to the substrate surface.

### FIELD OF THE INVENTION

This invention is directed towards fibers of fabric or other fibrous substrates coated with amine-containing polymers. These polymers impart durable anti-microbial activity, renewable control of certain odors, and the capacity to bind certain materials to the fabric surface.

### BACKGROUND OF THE INVENTION

Fabrics composed of only natural (e.g. cotton, wool, silk) or synthetic (e.g. polyester, nylon, acrylic) fibers are often lacking in desirable attributes. It is common in the textile industry to add a small weight component of various chemicals to the fabric to impart desired properties; these treatments are commonly referred to as “finishes”. Such chemical enhancers include dyes, optical brighteners, softeners, water repellents, water/oil repellents, insect repellents, anti-microbial and/or anti-fungal treatments, anti-static finishes, and hydrophilic finishes.

Durability is simultaneously a desired property and a significant challenge for any finish. Even molecules with only slight volatility will eventually evaporate; sunlight and air will slowly degrade others. Cleaning procedures such as laundering, dry-cleaning, and shampooing are the most significant challenges to fabric finish durability. Many finishes are removed from fabrics after only a few cleanings.

Various approaches have been taken to provide durable finishes. One method is to deposit chemicals, typically polymers, that are not readily solubilized and washed away after being precipitated onto the fabric. Alternatively, the active ingredient of a finish may be embedded in a laminant film that is applied to fabric; this procedure often allows for the slow release of the active ingredient into the surrounding fabric. However, the detergents and mechanical agitation of conventional cleaning procedures often eventually remove the polymer or laminant film when it is merely deposited onto the fiber surface.

When the fabric fibers contain available reactive groups such as in cotton, linen, wool, or silk, the finish may be bound to the fabric through covalent chemical bonds. This approach is very effective, but limited to a subset of fibers and finishes. One disadvantage to man-made fibers (e.g., regenerated cellulose, rayon or certain non-synthetic polyesters) and synthetic fibers (e.g. acrylic, lycra, polyester and nylon) is the essential absence of available reactive groups; the vast majority of such groups are used up in forming the polymer backbone. Thus it is difficult to attach a substantial amount of a finish to synthetic fibers via covalent bonding, and so this effective method of achieving finish durability is useless with synthetic fibers.

It would be desirable to provide a method for encasing fabric fibers, particularly synthetic fibers, in a polymeric coating. In this manner, the fibers would provide a structural support for the polymer sheath and enhance the polymer's durability to conventional cleaning processes such as laundering and dry cleaning. The polymer would provide desired characteristics to the fabric, potentially including the presentation of reactive groups on the fiber surface that could serve as attachment points for further fabric finishing. Hereinafter is described some “desired characteristics” that might be imparted by a finish.

U.S. Pat. No. 6,187,856, issued to Incorvia et al, teaches the use of crosslinked resins, formed from polyamidoamines and polychlorohydrin crosslinkers, to form durable films on fabrics. The resins of this patent are claimed to give durable anti-static properties to the fabric. Durability is defined in this patent as evidence of anti-static properties after dipping treated fabric into water heated at 80° C. for two twenty-minute intervals.

Anti-microbial finishes are highly desirable for many textile applications. They may be employed on fabrics used in settings requiring antiseptic conditions, such as in hospitals. They may also be useful for fabrics worn or used in commercial food preparation, hospitality settings, and other areas where there is the significant potential of exposing people to infectious bacteria.

There are only a handful of classes of anti-microbial compounds. Durability is a significant problem for them as most are small molecules that evaporate readily or can be washed away. Moreover, many anti-microbial compounds exhibit toxicity to humans. It would be desirable to invent a durable anti-microbial fabric finish that is innocuous to humans.

Various short (fifty amino acids or less), cytotoxic polypeptides have been identified (Maloy, et al., Biopolymers (Peptide Science) 37: 105-122 (1995)). They share the common trait of a high content of arginine and lysine residues, and carry a net positive charge at physiological pH. The mechanism of toxicity appears to be cell lysis mediated by electrostatic coordination of the peptide to the cell wall.

U.S. Pat. No. 5,300,287, issued to Park, teaches the derivatization of polyethyleneimine, particularly with polyethylene glycols, to form graft polymers which exhibit antimicrobial and antifungal activity. These polymers are particularly directed towards use in opthalmic products and contact lens care solutions.

U.S. Pat. No. 6,034,129, issued to Mandeville et al, teaches the use of cationic polymers to treat bacterial infections in mammals, specifically humans. The polymers described in the patent have amino or ammonium groups pendant from the polymer backbone.

The ability to eliminate or significantly diminish malodorous axillary (body) odor and foot odor is a desirable attribute for apparel fabrics. The chemical components of axillary odor are the waste by-products of certain bacteria that live off of the secretions from human sweat glands. These species of bacteria are called lipophilic diptheroids. Some three dozen molecules with potentially offensive odors have been identified in body odor (see, Preti, G. et al, J. Chem. Ecology, 1991, 17, 1469; Preti, G. et al, J. Chem. Ecology, 1992, 18, 1039; Preti, G. et al, J. Chem. Ecology, 1996, 22, 237; Proc. Nat. Acad. Sci. USA, 1996, 93, 6626). All of them are organic acids and the main contributor to the odor has been identified as trans-3-methyl-2-hexenoic acid. The chemical components of foot odor have similar origin; they are waste products of the bacteria brevidium epidermis. These molecules are also organic acids, and the most significant component is isovaleric acid (see, Kanda, F. et al, Brit. J. of Dermatology, 1990, 122, 771). It would be desirable to have a durable finish that would eliminate or significantly diminish malodorous body odor on fabrics. One approach is to include a bacteriocidal finish. However, these may not kill bacteria living on the skin and so odor may still be produced. Another method is to use a finish that absorbs the malodorous organic acids responsible for axillary and foot odor so that the volatile concentrations of the offensive organic acids are below the threshold of detectability. It would be greatly desirable to be able to recharge the absorptive capacity of such a finish by standard cleaning procedures.

U.S. Pat. No. 4,244,059, issued to Pflaumer, teaches the use of a water-soluble amine-containing polymer, Tydex-12 (Dow Chemical Co.), as an “odor absorbent compound”. Tydex-12 is applied to a soft, air-permeable fabric composed of cellulosic fibers, and the treated fabric is then used in the manufacture of panty-type garments. The treated fabric is designed to absorb odors emanating from the vagina and surrounding region. The patent makes no claims as to durability, nor does it make provisions to provide for durability of the polymer to the fabric during common cleaning processes such as laundering.

WO patent 97/34040, issued to Koizumi et al., teaches the use of polyamines as coatings for acrylic fibers to produce deodorizing fibers. In this patent, wet gel acrylic fibers containing acid groups are brought into contact with “an amino compound” with the stoichiometry adjusted so that there is an excess of amine groups. Electrostatic interactions between the amines and acid groups presumably are the source of durability. The fibers have been wet spun and not previously dried. After contacting the amine compound, the coated fiber is heated at between “100 and 180° C. under wet heat conditions.” Fiber products constructed from these fibers are able to deodorize acidic odors.

### SUMMARY OF THE INVENTION

This invention is directed towards durable finishes for fabrics and other fibrous substrates. The active components of the finishes are amine-containing polymers with reactive groups. The polymers become cross-linked on the substrate fiber surface and form a soft resinous coating that is durable to cleaning procedures. The reactive groups of the amine-containing polymer may be amines, but are not restricted to this functional group.

This invention is further directed to the fibers; yarns; woven, knitted or nonwoven fabrics and textiles; and finished goods (encompassed herein under the term “fibrous substrates”) treated with the amine-containing polymeric coating of the invention.

The fibrous substrates treated with the finish described herein take on properties that are not found in the native fabric, including anti-microbial properties and/or the ability to eliminate or greatly diminish the most offensive component of malodorous body odor. When applied to synthetic fabrics, such as polyester or nylon, the reactive groups of the present invention provide attachment points to make other finishes with reactivity complimentary to the amine-containing polymer (applied previously, simultaneously or in a later process) durable to cleaning procedures. This heightened durability can be brought about through the formation of ionic or covalent bonds with the reactive groups and/or to the amine groups of the present invention. The polymer coating also provides new opportunities for fabric dyeing. For example, reactive dyes can form covalent bonds with the amine-containing polymer and thus be used for dyeing synthetic fibers.

### DETAILED DESCRIPTION OF THE INVENTION

As used herein and in the appended claims, “a” and “an” mean one or more, unless otherwise indicated.

The term “durable” or “durability” as used herein describes a finished fibrous substrate in which the desired properties imparted to the substrate by the finish are observed after multiple launderings or dry cleanings.

For the purposes of this description and the accompanying claims, the term “amine-containing polymer” refers specifically to polymers that contain amine groups either within or pendant from the polymer backbone. For the purpose of this description, the term “amine group” describes primary, secondary and/or tertiary amine groups. The polymer may also contain quaternary amine groups, but the inclusion of quaternary amine groups without primary, secondary, or tertiary amine groups is insufficient to qualify such a polymer as an “amine-containing polymer” as described herein. The amine-containing polymer also contains reactive groups; these reactive groups may be but are not restricted to amine groups. Examples of alternative reactive groups include, but are not limited to, hydroxyls, thiols, and carboxylic acids.

The amine-containing polymer may be a homopolymer, copolymer, or terpolymer, and may come from natural sources or from synthetic preparation. Examples of amine-containing polymers from natural sources include amine-containing polysaccharides and amine-containing polypeptides. In a presently preferred embodiment, chitosan is such a natural polymer. Examples of synthetic amine-containing polymers include polyethyleneimine (PEI) and PEI derivatives, poly(vinylamine), poly(diallylamine), poly(allylamine), copolymers of diallylamine and allylamine, co-and terpolymers containing diallylamine and/or allylamine, and condensation polymers formed from polyamine monomers and monomers with two or more amine-reactive groups. Other examples of amine-containing polymers are poly(acrylates) composed entirely or in part of acrylate monomers which contain amine groups, poly(methacrylates) composed entirely or in part of methacrylate monomers which contain amine groups, and co- or terpolymers composed of acrylate, methacrylate and/or other vinyl monomers, in which polymers at least some and potentially all of the monomers contain amine groups.

Presently preferred embodiments of the invention include the synthetic polymers PEI and PEI derivatives, poly(vinylamine), and polymers containing diallylamine or allylamine. PEI can be derivatized with molecules containing such reactive groups as halohydrins, epoxides, organic acids, α,β-unsaturated organic acids, and carbonyls. PEI polymers and derivatized PEI polymers are commercially available from Nippon Shokubai and BASF. A presently preferred polymer is an epichlorohydrin-grafted PEI available from BASF under the trade name of Lupasol SC-86X.

The term “cross-linkers” as used herein describes molecules that contain two or more functional groups that form bonds with the reactive groups of the amine-containing polymer. The cross-linkers bind the amine-containing polymers together to form coatings of polymer film around the fibers. Fibers that contain reactive functional groups may also react with the cross-linkers to adhere the amine-containing polymer coating directly to the fiber.

In one embodiment, the amine groups of the amine-containing polymer are also the reactive groups used to form the durable fiber coating. Polymers that contain primary and/or secondary amines are particularly preferred in this embodiment. Those of skill in the art of chemistry will recognize that primary and secondary amines possess much greater versatility in bond formation than do tertiary amines, thereby broadening the types of potential cross-linkers. The reactive groups of the cross-linker should be present in sufficient quantity to form the durable coating, but preferably in a sub-stoichiometric amount relative to the amine groups of the polymer, particularly when a second finish will later be made durable by reaction with the amine-containing polymer. It is particularly desirable in this embodiment that the cross-linker reactivity be significantly amine-selective, so that the cross-linkers react efficiently to bind the polymers together. In one embodiment, it is also desirable, but not required, that the basicity of the nitrogen atoms that participate in the cross-linking reaction be substantially unchanged after the reaction. Specific amine-reactive groups include alkyl halides, isothiocyanates, isocyanates, acyl azides, N-hydroxysuccinimide esters, sulfonyl chlorides, aldehydes, glyoxals, epoxides, oxiranes, carbonates, arylating agents, imidoesters, carbodiimides, anhydrides, and halohydrins. In a presently preferred embodiment, the cross-linker contains halohydrin or epoxide reactive groups. Examples of these cross-linkers are 1,3-dichloro-2-propanol and 1,4-butanediol diglycidyl ether (Sigma-Aldrich Corporation).

In another embodiment, the amine-containing polymer also contains non-amine reactive groups. The presence of non-amine reactive groups is particularly valuable when the amine groups of the polymer are exclusively or almost exclusively tertiary amine groups. Examples of non-amine reactive groups that are of use in the present invention include hydroxyls, thiols, and carboxylic acids. In a presently preferred embodiment, the reactive groups are hydroxyls. It is particularly desirable that the cross-linking reaction does not affect the basicity of the amines in the resulting film. A catalyst may optionally be included to facilitate cross-linking.

Hydroxyl-reactive functional groups include epoxides, halohydrins, oxiranes, carbonyl diimidazole, N,N′-disuccinimidyl carbonate or N-hydroxysuccinimidyl chloroformate, alkyl halogens, isocyanates, and N-methylol ureas. Thiol groups react with haloacetyl and alkyl halide derivatives, maleimides, aziridines, acryloyl derivatives, arylating agents, and thiol-disulfide exchange reagents such as pyridyl disulfides, disulfide reductants, and 5-thio-2-nitrobenzoic acid. Carboxylate reactive groups include diazoalkanes and diazoacetyl compounds, oxazolines, carbonyl diimidazole, carbodiimides, and N-methylol ureas. Preferred cross-linkers are diepoxides (Sigma-Aldrich corp.), N-methylol ureas such as dimethyloldihydroxyethyleneurea (DMDHEU) (PatCoRez P-53, BFGoodrich), and blocked polyisocyanates such as Repearl MF (Mitsubishi Chemical Co.). The finish that is applied to the fibrous substrate is a solution comprising at least an amine-containing polymer, a cross-linker, and a volatile solvent. It is desirable that the polymer and the cross-linker be soluble in the solvent. A particularly preferred solvent is water. The pad solution preferably contains amine-containing polymer at between about 0.01% and about 75% by weight, more preferably about 0.05% and about 50% by weight, and most preferably about 0.1% and about 40% by weight. The pad solution preferably contains a cross-linker at between about 0.001% and about 40% by weight, more preferably about 0.01% and about 30% by weight, and most preferably about 0.05% and about 20% by weight. The finish solution may also include other components as described below.

In a particular embodiment of the invention, the amine-containing polymer is partially reacted with a cross-linker prior to being placed in the treatment bath, e.g. substantially only one of the two or more reactive groups of the cross-linker pre-reacts with the amine-containing polymer. The resulting grafted polymer is then added to a treatment bath and applied to fabric, after which the fabric is cured to complete the reaction with the cross-linker. The grafted polymer may be the only component of the treatment bath; alternately other components such as additional cross-linkers and wetting agents may be included.

The reaction of the amine-containing polymer with certain cross-linker functional groups, such as halohydrins, results in the formation of mineral acids that lower the pH of the finish and may slow the rate and decrease the extent of cross-linking. To control this deleterious effect, a buffering agent may be added to the finish solution. Buffering agents are weak acids or bases that tend to hold solutions containing them within ±1 pH point of the buffering agents' pKₐ. One skilled in the art will appreciate that an optimal buffer solution consists of equimolar portions of the buffering agent and its corresponding conjugate acid or base, the latter often being formed by addition of a strong acid or base. Lists of buffering agents can be found in Lange's Handbook of Chemistry, 14^{th} edition, ed. J. A. Dean, McGraw-Hill, Inc., section 8, p.p. 103-112. If used, a buffering agent should be chosen so that the pKₐ of the buffer lies within the optimal pH range of the reaction. This pH range is dependent on the identities of the reactive group of the amine-containing polymer and of the cross-linker. The buffer must also be chosen so as to be unreactive with the cross-linker or the amine-containing polymer. The amount of buffering agent should be slightly more than equimolar to the theoretical total amount of acid generated by complete reaction of the cross-linker.

The finish solution may also include other additives. For example, amine groups are prone to oxidation, the by-products of which are often yellow-brown in color. The addition of an anti-oxidant to the finish solution can minimize the extent of oxidation both in the stored state and while the finish is being applied and cured on the fabric. A presently preferred anti-oxidant is phosphoric acid. Optical brighteners (such as, for example, the Leucophor products from Clariant Corp. or the Uvitex products from Ciba Corp.) may be included in the finish solution. Whitening agents, such as sodium tetraborate, may also be included in the solution. The finish solution may also contain a wetting agent, such as WetAid NRW (BFGoodrich Corp.), to aid the equal spread of the finish over the fibers. This is particularly useful when the fiber material is hydrophobic. Additional additives can be added to the solution as needed.

The finish can be applied to the fibrous substrate by exposing the substrate to the finish solution by methods known in the art, such as soaking, spraying, dipping, fluid-flow, and padding. The exposed fibrous substrate is then heated to remove the volatile solvent and to speed up the reaction of the polymer with the cross-linker. Alternatively, the fibers or yarns may be exposed to the finish solution by soaking, spraying or dipping. After the finish is cured in place, the fibers or yarns may be woven or knit into fabrics.

The finish solution may be applied to the fibrous substrate at any temperature above the freezing point and below the boiling point of the solvent. In the present embodiment, the application temperature is preferably between 5 and 90° C., more preferably between 10 and 50° C., and most preferably at room temperature. The treated fabric should be cured at a temperature high enough to induce formation of the sheath in a very short time, preferably less than five minutes, more preferably a minute or less. In the present embodiment, the curing temperature is preferably between 100 and 180° C., more preferably between 110 and 140° C.

The present invention is further directed to the fibrous substrates treated with the finish described above. Substrates thus treated will possess properties not found in untreated substrates. These properties may include anti-microbial properties and the ability to absorb malodorous organic acids via acid-base reactivity of the acids with the amine groups of the finish. In the case of substrates constructed all or in part of inert, synthetic fibers, the treated fibers present reactive groups on their surfaces. A further treatment with a second finish containing groups that react with the modified fibers will result in durability for the second finish.

Examples of desired durable second finishes include dyes, softeners, water repellents, water/oil repellents, insect repellents, anti-microbial and/or anti-fungal treatments, anti-static finishes, and hydrophilic finishes.

In one embodiment of the invention, the treated fibrous substrate has antimicrobial properties. Fabrics and other fibrous substrates that either prevent the growth of or actively kill bacteria, mold, or fungi are very desirable, particularly in settings where biologically contaminated fabrics can be the source of infection such as in hospital and food preparation settings. The finish of the present invention has been shown to provide durable, non-leaching antimicrobial properties to treated fabrics. Not to be bound by theory, it is believed that the action of the finish can be attributed to the cationic charge of the polymer. The cell walls of microbes are composed primarily of negatively charged phosphate lipid bilayers. In theory, the electrostatic coordination of the lipid bilayer to the finish polymer disrupts the cell wall and kills the organism.

Another embodiment of the present invention is the preparation of treated fibrous substrates that absorb and deodorize organic acids, which gives such substrates the ability to eliminate or greatly diminish offensive body odor. The odor-absorbing capacity of the fabric can be recharged when necessary by conventional laundering procedures. The molecular sources of offensive body odor are primarily the waste products of a species of bacteria named lipophilic diphtheroids. This species of bacteria lives on the skin surface of humans and primarily digests the secretions of the apocrine glands. The malodorous waste products of lipophilic diphtheroids are organic acids, with the most significant component being 3-methyl-2-hexenoic acid. Volatile organic acids are commonly considered to have highly offensive odors even in extremely low concentrations. The odor-absorptive capacity of the treated fibrous substrate stems from the basicity of the amine groups of the finish. Acids react with the free amine groups of the amine-containing polymer to form non-volatile ionic complexes. The extent to which this ionic complexation occurs depends on the relative strength of the acid and base. In the case of the present invention, the reaction is biased towards formation of the ionic complex to such a degree that only between one acid molecule in ten thousand to one acid molecule in a million would be found in the non-ionized, potentially volatile form. Thus, as long as unreacted amine groups are available in the treated fabric, the concentration of volatilized organic acid around the treated fabric will be lowered to the point of being undetectable or scarcely detectable.

An advantage to the present invention over conventional odor-absorbing material such as activated carbon is the ability to recharge the odor-absorptive capacity of the fibrous substrate. As amines are weak bases, exposing the substrate to an aqueous solution with a pH at or above the pK_{b} of the base will deprotonate most of the amine complexes and result in separation of the amine-acid complexes. The conjugate base forms of the malodorous organic acids will be washed away in the laundry liquor, leaving behind free amine groups on the fiber surface. A pH of 10 is above the pK_{b} of most amines, and laundry detergent solutions such as Tide® typically have this pH or higher. Therefore, a conventional laundering procedure is sufficient to recharge the odor-absorptive capacity of the fabric.

A further embodiment of the present invention is the preparation of a fiber surface with reactive amine groups that can participate in binding other finishes to the fibrous substrate in a durable fashion. This is particularly useful when the fiber is composed of polymers without a significant number of reactive groups, such as in polyester and nylon. The fibers treated with the amine-containing polymeric finish of the present invention present reactive groups on their surfaces. A further treatment with a second finish containing groups that react with the modified fibers will result in durability for the second finish. Examples of desired durable second finishes include dyes, softeners, water repellents, water/oil repellents, insect repellents, anti-microbial and/or anti-fungal treatments, anti-static finishes, and hydrophilic finishes.

The nature of the reactive functional group of a second finish is dependent on the reactive groups of the amine-containing polymer, as described vide supra. Examples of amine-reactive groups include isothiocyanates, isocyanates, acyl azides, N-hydroxysuccinimide esters, sulfonyl chlorides, aldehydes, glyoxals, epoxides, oxiranes, carbonates, arylating agents, imidoesters, carbodiimides, anhydrides, and halohydrins. Hydroxyl-reactive functional groups include epoxides, halohydrins, oxiranes, carbonyl diimidazole, N,N′-disuccinimidyl carbonate or N-hydroxysuccinimidyl chloroformate, alkyl halogens, isocyanates, and N-methylol ureas. Thiol groups react with haloacetyl and alkyl halide derivatives, maleimides, aziridines, acryloyl derivatives, arylating agents, and thiol-disulfide exchange reagents such as pyridyl disulfides, disulfide reductants, and 5-thio-2-nitrobenzoic acid. Carboxylate-reactive groups include diazoalkanes and diazoacetyl compounds, carbonyl diimidazole, carbodiimides, and N-methylol ureas.

The following examples are intended for illustrative purposes only. Those of skill in the art will recognize other embodiments, all of which are considered part of the present invention.

### EXAMPLES

### Example 1

A 100.0 g solution of 10% polyethyleneimine (PEI, Mol. Wt. 70,000, Nippon Shokubai) and 5% 1,3-dichloro-2-propanol (DCP, Aldrich Chemical Corp.) at pH 9.0 was prepared by combining 33.3 g of PEI (30% solution) and 50.0 g water, adjusting the pH with hydrochloric acid (VWR), adding additional water to make up mass to 95.0 g, and then adding 5.0 g DCP. A swatch of undyed, woven, microdenier polyester fabric was dipped in this solution, processed through pad rollers or “padded”, and cured in a forced-air oven at 121° C. for five minutes. A control swatch (C-1) of the same fabric was dipped in water at pH 9.0, and a second control swatch (C-2) was dipped in 10% PEI at pH 9.0. All control swatches were padded and then cured in a forced-air oven at 121° C. for five minutes. All of the swatches were cut into quarters. One set of quarters was rinsed individually under cold tap water for 20 minutes; this set is referred to herein as the zero (0) home laundering (HL) samples. The remaining three sets of quarters were machine laundered five, ten or twenty times according to the American Association of Textile Chemists and Colorists (AATCC) method 124-1996, reported in the AATCC technical manual (1999). Upon completion of laundering, all of the quarters were cut in half. One set of halves was dyed as described below, the other set of halves was used for analysis of odor absorption.

The sample swatches to be dyed were placed in a 0.1% aqueous solution of dye Acid Red 37 (20:1 liquor:goods ratio) for thirty (30) minutes. Upon completion of dyeing, the samples were removed from the dye bath and rinsed individually under cold tap water for one minute. The degree of coloring was noted and recorded in Table 1 under the column headings of “Color” (“d.”=dark, “l.”=light). Untreated polyester has little or no affinity for acid dyes, whereas PEI has a strong affinity for acid dyes, so this test is an excellent indication of the presence of PEI.

The odor analysis was performed as follows: one drop of a 0.01% butyric acid solution was placed onto each swatch, then the drop was allowed to dry. A panel of judges then smelled each swatch and rated the odor as strong, faint, or not noticeable. The generalized impressions of the judges are recorded in Table 1 under the column headings of “Odor”.

TABLE 1

| Sample | 0 HL | | 5 HL | | 10 HL | | 20 HL | |
|---|---|---|---|---|---|---|---|---|
| &Rectversolid; | Color | Odor | Color | Odor | Color | Odor | Color | Odor |
| Treated | d. red | none | red | none | red | none | I. red | faint |
| C-1 | red | strong | white | strong | white | strong | white | strong |
| C-2 | d. red | none | I. pink | strong | white | strong | white | strong |

### Example 2

A solution of 4% PEI (BASF, Mn=60,000), 3% 1,4-butanedioldiglycidyl ether (Sigma-Aldrich Corp.), and 0.1% WetAid NRW (BFGoodrich) was prepared by combining 24.0 g PEI, 0.3 g WetAid NRW and 2400.0 g distilled water in a beaker. The pH of this solution was adjusted to 9.0 with 85% phosphoric acid (Baker). Sufficient water to bring the combined mass up to 291.0 g was added, followed by 9.0 g of 1,4-butanedioldiglycidyl ether. The formulation (Formulation A) was then stirred thoroughly.

Formulation B was an aqueous solution of 4% PEI and 0.1% WetAid at pH 9.0 (300.0 g).

Formulation C was an aqueous solution of 3% 1,4-butanedioldiglycidyl ether and 0.1% WetAid (300.0 g).

Formulation D was an aqueous solution of 0.1% WetAid (300.0 g) adjusted to pH 9.0 with sodium hydroxide (Aldrich.).

Swatches of three styles of polyester fabric and a cotton fabric were dipped in each solution. The swatches were then padded to a uniform wet pick-up, and then dried at 157° C. for fifteen seconds past the point of fabric dryness. The samples were then laundered thirty times according to the AATCC method 124-1996. Small swatches were cut from the fabric before laundering and after one and thirty launderings. Odor absorption testing was performed on each small swatch as described in Example 1.

The swatches treated with Formulation A absorbed odors after 30 launderings, whereas the other treated samples did not.

### Example 3

Formulation A, a 500.0 g solution of 5% ethoxylated PEI (BASF), 0.1% WetAid NRW (BFGoodrich) and 3% 1,4-butanedioldiglycidyl ether (Sigma-Aldrich Corp.), was prepared by combining 67.5 g ethoxylated PEI, 0.5 g WetAid and 417.0 g water. 15.0 g 1,4-butanedioldiglycidyl ether was then added and the solution was stirred thoroughly.

Formulation B consisted of a 500.0 g 0.1% WetAid solution.

Swatches of three woven polyester styles, a cotton knit, and a 90/10 cotton/lycra knit were cut and dipped in one of the two formulations. The swatches were padded to a uniform wet pick-up, then dried at 157° C. for fifteen seconds past the point of fabric dryness. The samples were then laundered thirty times according to the AATCC method 124-1996. Small swatches were cut from the fabric before laundering and after one and thirty launderings.

Odor absorption testing was performed on the swatches laundered thirty times using 0.01% butyric acid. A panel of judges compared the odor of the treated samples to the untreated controls. The controls were assigned a value of three (3). If no odor could be detected on the treated swatch, it was assigned a value of zero (0). Any detectable butyric acid odor on the treated fabrics were ranked from one to three relative to the control. The thirty-home laundering small swatches were also dyed according to the procedure described in Example 1.

The results from the dyeing and smell testing are tabulated in Table 2. The polyester swatches are identified as PET#, the cotton as COT, and the cotton/lycra blend as C/L. A suffix of T indicates treatment with formulation A, the suffix U indicates treatment with formulation B.

TABLE 2

| Sample | panelist | | | | | |
|---|---|---|---|---|---|---|
| ID | 1 | panelist 2 | panelist 3 | Average | StdDev | dyeshade |
| PET1-T | 0 | 0 | 0 | 0.00 | 0.00 | pink |
| PET1-U | 3 | 3 | 3 | 3.00 | 0.00 | white |
| PET2-T | 1 | 0 | 0 | 0.33 | 0.58 | pink |
| PET2-U | 3 | 3 | 3 | 3.00 | 0.00 | white |
| PET3-T | 0 | 0 | 0 | 0.00 | 0.00 | pink |
| PET3-U | 3 | 3 | 3 | 3.00 | 0.00 | white |
| COT-T | 0 | 0 | 0 | 0.00 | 0.00 | red |
| COT-U | 3 | 3 | 3 | 3.00 | 0.00 | pink |
| C/L-T | 0 | 0 | 1 | 0.33 | 0.58 | red |
| C/L-U | 0 | 3 | 3 | 2.00 | 1.73 | pink |

### Example 4

A 100.0 g portion of 30% PEI (Nippon Shokunai, Mn=70,000) was combined with 7.8 g glycidol (Sigma-Aldrich). The glycidol was allowed to react with the PEI for 1.5 hours at room temperature. Complete reactivity between the polyethyleneimine and glycidol was assumed. The resulting product, a glycidol-grafted polyethyleneimine, is referred to hereinafter as PEI-g20. The PEI-g20 was used without further purification as a 35% aqueous solution.

A series of pad-bath formulations were prepared; all were adjusted to pH 3.5 with hydrochloric acid (VWR). Formulation A consisted of water. Formulation B consisted of 10% PatCoRez P-53 (DMDHEU resin, BFGoodrich). Formulation C consisted of 12.6% PEI-g20. Formulation D consisted of 10% PatCoRez P-53 and 12.6% PEI-g20. For each formulation, two swatches of cotton were dipped and then padded and dried/cured for three minutes. One swatch for each formulation was laundered five times according to the MTCC method 124-1996.

The swatches were then tested for anti-microbial activity according to AATCC test method 100. The results are recorded in Table 3. The sample IDs correspond to the formulation that the sample was dipped in. the term “TMTC” indicates the presence of too many bacterial colonies to count. It is noteworthy that the PEI-g20 provides an essentially instantaneous kill of the test bacteria both at zero and five home launderings (Samples C and D). The DMDHEU resin in PatCoRez P-53 also has anti-microbial activity, probably due to the slow release of formaldehyde as it decomposes (Sample B); however, the effect is much slower. The untreated control (Sample A) has no anti-microbial activity.

TABLE 3

| | | # of Colonies | | |
|---|---|---|---|---|
| Sample ID | # HLs | 0 hours | 24 hours | % Kill |
| A | 0 | TMTC | TMTC | 0% |
| | 5 | 1589 | TMTC | 0% |
| B | 0 | TMTC | 0 | 100% |
| | 5 | TMTC | 0 | 100% |
| C | 0 | 0 | 0 | 100% |
| | 5 | 423 | 0 | 100% |
| D | 0 | 428 | 0 | 100% |
| | 5 | 0 | 0 | 100% |

### Example 5

A 400 liter solution of 25% Lupasol SC-86X (BASF), 1.5% Repearl MF (Mitsubishi Chemical Co.) and 0.1% WetAid NRW (Noveon) was prepared and placed in a pad bath on a Montfort tenter frame. Six styles (1-6) of dry, open-width 100% polyester fabric moving at 23.5 yards per minute was passed through this solution, then through a squeeze roll pad set at 55 psi to achieve an average wet pick-up of 106%. The fabrics then passed through an oven set at 320° F.; the fabrics had a dwell time of 14 seconds at this temperature. The finished fabric was tested for its ability to absorb butyric acid odor, then swatches of each finished style were laundered twenty times according to AATCC method 124-96 and tested again. Untreated swatches of the same six styles were also tested in the same fashion as a comparison. The results are recorded in Table 4.

The testing was performed as follows: A drop of a dilute butyric acid was placed on a swatch and allowed time to absorb into the fabric, then a panel of judges would smell the swatch. If no odor could be detected by any of the judges, a drop of a more concentrated butyric acid solution was placed on the fabric and it was evaluated again. This procedure was repeated until all of the judges could smell the butyric acid. Each judge recorded the concentration of butyric acid (in parts per million) at which he was able to detect an odor; this concentration is referred to as the odor score. The odor scores for each swatch were then averaged.

TABLE 4

| | |
|---|---|
| Parameters | Average |

| | |
|---|---|
| Treated | Odor Score |

| Style | (Y/N) | 0 HL | 20 HL |
|---|---|---|---|
| 1 | Y | 1000 | 600 |
| 1 | N | 133 | 167 |
| 2 | Y | 667 | 667 |
| 2 | N | 83 | 117 |
| 3 | Y | 867 | 667 |
| 3 | N | 117 | 117 |
| 4 | Y | 1000 | 733 |
| 4 | N | 67 | 167 |
| 5 | Y | 1000 | 533 |
| 5 | N | 200 | 267 |
| 6 | Y | 1000 | 1000 |
| 6 | N | 67 | 467 |

What is claimed is:

1. A finish for a fibrous substrate comprising an amine-containing polymer with reactive groups, a cross-linker, and a volatile solvent, and wherein the finish is durable to cleaning procedures.

2. A finish according to claim 1 which provides anti-microbial properties to the fibrous substrate.

3. A finish according to claim 1 which provides the fibrous substrate with the ability to eliminate or greatly diminish offensive body odor.

4. A finish according to claim 3 wherein the ability is rechargeable.

5. A fibrous substrate comprising amine-containing polymers crosslinked on the fiber surface of the fibrous substrate to form a resinous coating durable to cleaning procedures.

6. A fibrous substrate according to claim 5 which exhibits durable anti-microbial properties.

7. A fibrous substrate according to claim 5 which exhibits the durable ability to eliminate or greatly diminish offensive body odor.

8. A fibrous substrate according to claim 7 wherein the ability is rechargeable.

9. A fibrous substrate according to any one of claims 5 to 8 which is a synthetic fabric that further comprises at least one additional finish, wherein the additional finish is durable to cleaning procedures.

10. A fibrous substrate according to claim 9 wherein the additional finish is a reactive dye.

11. A method for providing anti-microbial properties to a fibrous substrate, the method comprising:
exposing the fibrous substrate to a treatment composition comprising an amine-containing polymer with reactive groups, a cross-linker, and a volatile solvent; and
curing the fibrous substrate;
to give a fibrous substrate exhibiting durable anti-microbial properties.

12. A method for providing a fibrous substrate with the ability to eliminate or greatly diminish offensive body odor, the method comprising:
exposing the fibrous substrate to a treatment composition comprising an amine-containing polymer with reactive groups, a cross-linker, and a volatile solvent; and
curing the fibrous substrate;
to give a treated fibrous substrate which exhibits the ability to durably eliminate or greatly diminish offensive body odor.

13. A method according to claim 12 which comprises the further step of exposing the treated fibrous substrate to an aqueous solution with a pH at or above 10, to recharge the odor-absorptive ability of the fibrous substrate.

14. A method for treating a synthetic fibrous substrate to provide durable finishes on the synthetic fibrous substrate, the method comprising:
exposing the fibrous substrate to a first finish comprising an amine-containing polymer with reactive groups, a cross-linker, and a volatile solvent to give a treated fibrous substrate with reactive groups on its surface;
curing the treated fibrous substrate; and
exposing the treated fibrous substrate to a second finish containing groups that react with the reactive groups on the treated fibrous substrate;
to give a synthetic fibrous substrate wherein the second finish is durable to cleaning procedures.

15. A method according to claim 14 wherein the synthetic fibrous substrate is exposed to the first and the second finishes simultaneously.

16. A method according to claim 14 wherein the synthetic fibrous substrate is exposed to the second finish after it is exposed to the first finish and either before or after the curing step.

17. A method according to any of claims 14 to 16 wherein the second finish is a reactive dye.

18. A method according to any of claims 11 to 17 wherein the amine-containing polymer is partially reacted with the cross-linker prior to being placed in the volatile solvent.
